(19) United States
(12) Patent Application Publication
(10) Pub. No.: US 2010/0066112 A1
(43) Pub. Date: Mar. 18, 2010

(54) Decorative assembly for a vehicle

(76) Inventor: Yu-Chih Sun, Sinjhuang City (TW)

Correspondence Address: ELIZABETH CHIEN-HALE, 40087 MISSION BLVD. BOX 367, FREMONT, CA, 94539, US

(21) Appl. No.: 12/283,662

(22) Filed: Sep. 15, 2008

(51) Int. Cl. B62D 39/00

(52) U.S. Cl. 296/1.07

(57) ABSTRACT

A decorative assembly has a base, a decorative element and a cover. The base has a chamber defined in one side of the base. The decorative element is detachably held in the chamber of the base. The transparent cover is attached to the base and closes the chamber to make the decorative element visible in the base through the cover. Accordingly, the decorative assembly can be mounted on a handle of a vehicle door or any location of a vehicle, such that the decorative assembly is convenient and versatile in use.

### BACKGROUND OF THE INVENTION

1. Field of the Invention

The present invention relates to a decorative assembly, and more particularly to decorative assembly for a vehicle and being convenient and versatile in use.

2. Description of Related Art

To decorate a vehicle, three conventional ways are applied and including baked-enamel coating, adhesive paper and ornaments. However, for a baked-enamel coating process, to paint the whole outer surface of a vehicle is necessary and this is very expensive. For an adhesive paper, to use adhesive papers is cheaper than the baked enamel coating process but to smoothly attach adhesive papers onto vehicles is very difficult so that bubbles are always generated to cause the appearance of the vehicle not aesthetic.

In addition, the conventional ornaments are not changeable after being attached to a vehicle, so the conventional ornaments are not versatile in use.

To overcome the shortcomings, the present invention tends to provide a decorative assembly to mitigate or obviate the aforementioned problems.

### SUMMARY OF THE INVENTION

The main objective of the invention is to provide a decorative assembly for a vehicle and being convenient and versatile in use. The decorative assembly comprises a base, a decorative element and a cover. The base has a chamber defined in one side of the base. The decorative element is detachably held in the chamber of the base. The transparent cover is attached to the base and closes the chamber to make the decorative element visible in the base through the cover.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a handle for a vehicle door with a decorative assembly in accordance with the present invention;

FIG. 2 is an exploded perspective view of the handle with the decorative assembly in FIG. 1;

FIG. 3 is a cross sectional top view of the decorative assembly in FIG. 1;

FIG. 4 is an operational perspective view of a vehicle with multiple decorative assemblies in accordance with the present invention;

FIG. 5 is a perspective view of a handle for a vehicle door with another embodiment of a decorative assembly in accordance with the present invention;

FIG. 6 is a perspective view of a handle for a vehicle door with another decorative assembly in accordance with the present invention; and

FIG. 7 is a block diagram of a decorative element of a decorative assembly in accordance with the present invention.

### DETAILED DESCRIPTION OF PREFERRED EMBODIMENT

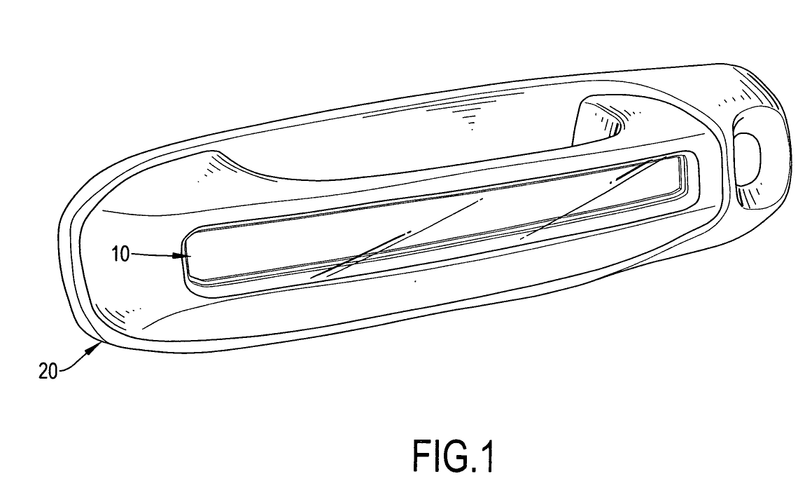

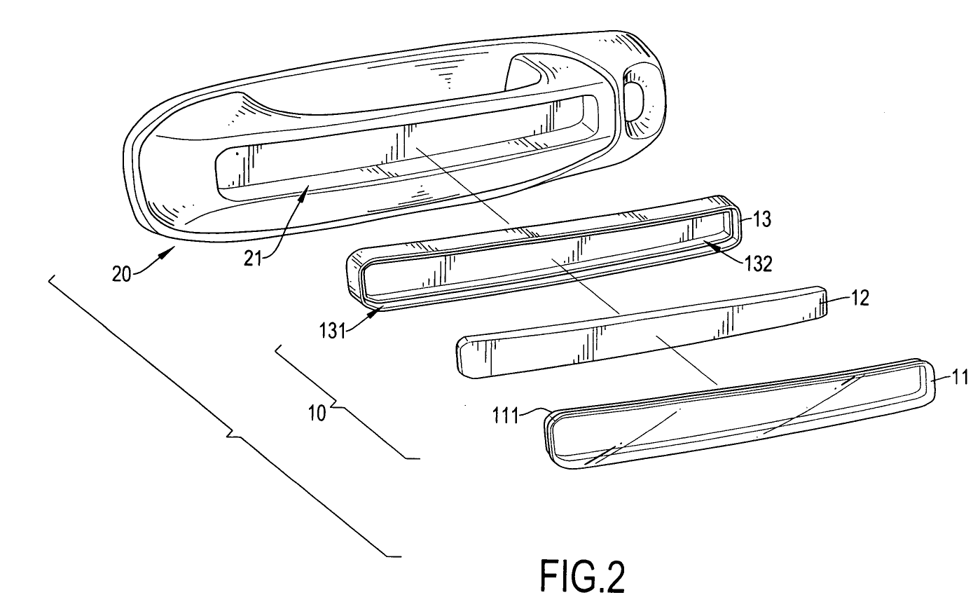

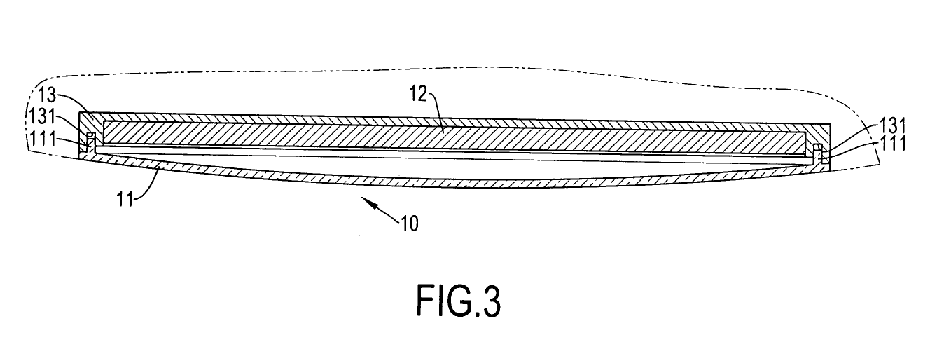

With reference to FIGS. 1 and 2, a decorative assembly (10) in accordance with the present invention may be mounted on a handle (20) for a vehicle door and comprises a base (13), a decorative element (12) and a transparent cover (11). The base (13) may be rectangular and elongated, may be mounted in a recess (21) defined in the handle (20) and has a chamber (132) defined in one side of the base (13) and having an opening in the side of the base (13). The base (13) may further have a first connection device mounted on the base (13). The first connection device may be an annular groove (131) defined around the opening of the chamber (132) as shown in FIG. 3.

The decorative element (12) may be rectangular and elongated and is detachably held in the chamber (132) of the base (13). The decorative element (12) may have figures or patterns formed or printed on the decorative element (12) to provide aesthetic effects. Because the decorative element (12) is detachable from the chamber (132) of base (13), decorative elements (12) with different patterns can replace with an old one such that the appearance of the decorative assembly (10) is changeable and versatile.

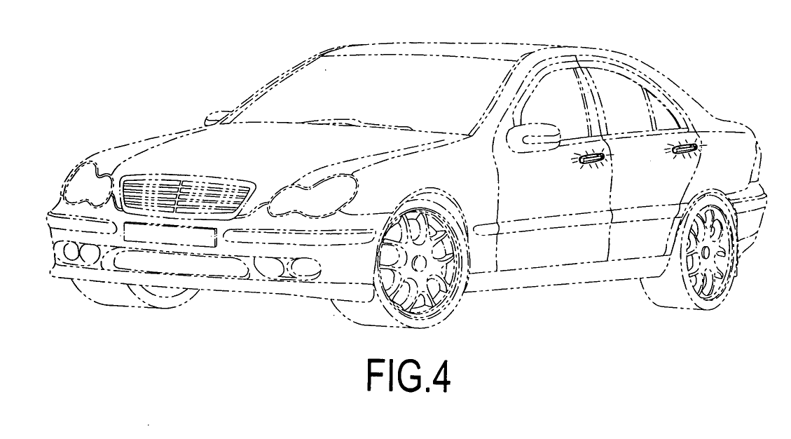

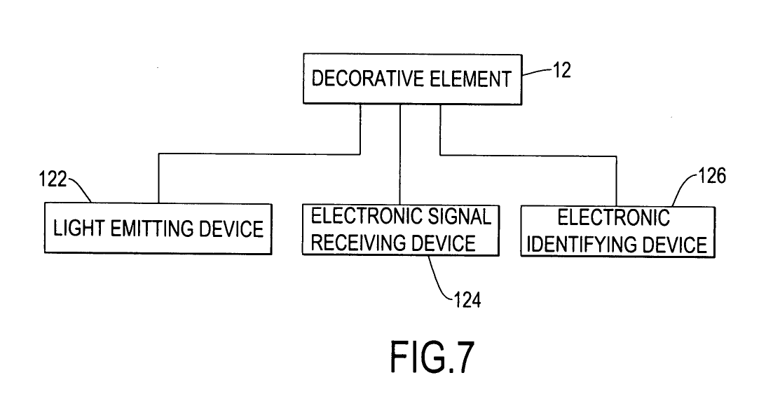

With further reference to FIGS. 4 and 7, the decorative element (12) further comprises a light emitting device (122), an electronic signal receiving device (124) or an electronic identifying device (126). The light emitting device (122) may be light emitting diodes (LEDs) or the like and can emit light out from the transparent cover (11) to improve visional effect of the decorative assembly (10) and safety of driving the vehicle. The electronic signal receiving device (124) may be an infrared ray signal receiving device to receive infrared ray signal and connected to the light emitting device (122) to make the light emitting device (122) to emit light in specific manners. The electronic identifying device (126) may be a finger print scanner or the like to allow a user to unlock the vehicle door without using a key. With such auxiliary devices (122,124,126), the decorative assembly (10) is versatile in use.

The transparent cover (11) may be rectangular and elongated, is attached to the base (13) and closes the chamber (132) to make the decorative element visible (12) in the base (13) through the cover (11). With the cover (11), the decorative element (12) is provided with a protection effect to keep the decorative element (12) from being damaged by rain, dusts or the like. The cover (11) has a second connection device detachably connected with the first connection device on the base (13). In a preferred embodiment, with further reference to FIG. 3, the second connecting device is an annular rib (111) formed on one side of the cover (11) and engages the annular groove (131) in the base (13) to detachably mounted the cover (11) on the base (13).

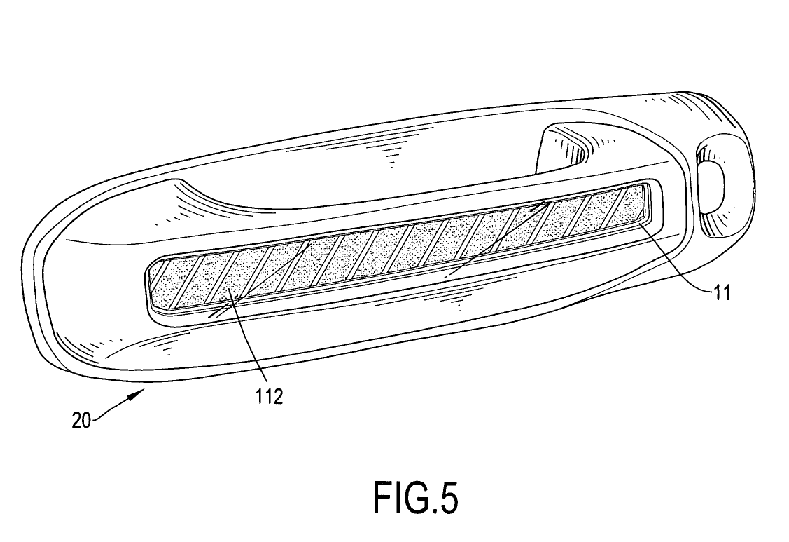

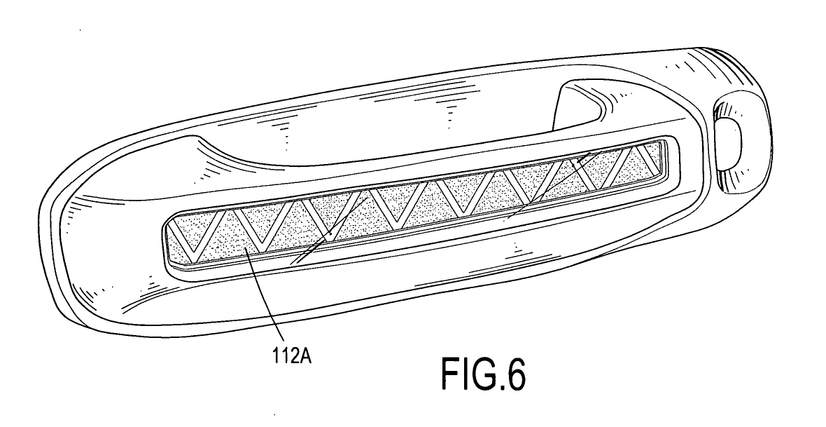

Furthermore, with reference to FIGS. 5 and 6, the cover (11) may further have multiple reflecting elements (112,112A) mounted on the cover (11) to form different patterns and provide a further aesthetic effect.

Because the decorative assembly (10) in accordance with the present invention is simplified in structure, the cost for using the decorative assembly (10) is low. Additionally, the decorative assembly (10) can be easily mounted on a recess (21) of a handle (20) of a vehicle door or any location of a vehicle by glue, the decorative assembly (10) in accordance with the present invention is convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A decorative assembly for a vehicle comprising:
a base having a chamber defined in one side of the base;
a decorative element detachably held in the chamber of the base;
a transparent cover attached to the base and closing the chamber to make the decorative element visible in the base through the cover.

2. The decorative assembly as claimed in claim 1, wherein the decorative element further comprises a light emitting device.

3. The decorative assembly as claimed in claim 2, wherein the decorative element further comprises an electronic signal receiving device.

4. The decorative assembly as claimed in claim 3, wherein the decorative element further comprises an electronic identifying device.

5. The decorative assembly as claimed in claim 4, wherein the cover further has multiple reflecting elements mounted on the cover.

6. The decorative assembly as claimed in claim 1, wherein the decorative element further comprises an electronic signal receiving device.

7. The decorative assembly as claimed in claim 1, wherein the decorative element further comprises an electronic identifying device.

8. The decorative assembly as claimed in claim 1, wherein the cover further has multiple reflecting elements mounted on the cover.

9. A handle for a vehicle door comprising:
a handle body having a recess defined in the handle body; and
a decorative assembly held in the recess in the handle body and comprising
a base having a chamber defined in one side of the base;
a decorative element detachably held in the chamber of the base;
a transparent cover attached to the base and closing the chamber to make the decorative element visible in the base through the cover.

10. The handle as claimed in claim 9, wherein the decorative element further comprises a light emitting device.

11. The handle as claimed in claim 10, wherein the decorative element further comprises an electronic signal receiving device.

12. The handle as claimed in claim 11, wherein the decorative element further comprises an electronic identifying device.

13. The handle as claimed in claim 12, wherein the cover further has multiple reflecting elements mounted on the cover.

14. The handle as claimed in claim 9, wherein the decorative element further comprises an electronic signal receiving device.

15. The handle as claimed in claim 9, wherein the decorative element further comprises an electronic identifying device.

16. The handle as claimed in claim 9, wherein the cover further has multiple reflecting elements mounted on the cover.
